(19) United States
(12) Patent Application Publication
(10) Pub. No.: US 2016/0347189 A1
(43) Pub. Date: Dec. 1, 2016

(54) COIL UNIT AND POWER SUPPLY SYSTEM

(71) Applicant: Yazaki Corporation, Tokyo (JP)

(72) Inventors: Takahiro Nakahara, Susono-shi (JP); Ryohei Nishizaki, Susono-shi (JP); You Yanagida, Susono-shi (JP)

(21) Appl. No.: 15/232,322

(22) Filed: Aug. 9, 2016

Related U.S. Application Data
(63) Continuation of application No. PCT/JP2015/051479, filed on Jan. 21, 2015.

(30) Foreign Application Priority Data
Feb. 14, 2014 (JP) 2014-026081

(51) Int. Cl. B60L 11/18; H01F 27/24; H02J 50/12; H01F 27/28

(52) U.S. Cl. CPC B60L 11/182; H01F 27/2823; H01F 27/24; H02J 50/12

(57) ABSTRACT

Provided is a coil unit suppressing heat generated in the coil unit and a power supply system including the coil unit. The power receiving unit includes a part of screw bodies fixing a circuit board of a power supply side capacitor, an extension line, and the extension line, and the other part of screw bodies fixing the extension line, the extension line and a pair of lead wires. The plurality of screws includes copper or aluminum.

### BACKGROUND OF THE INVENTION

Field of the Invention

The invention is related to a coil unit used for transmitting/receiving power and a power supply system including the coil unit.

### DESCRIPTION OF THE RELATED ART

Recently, in a charger for a secondary battery (hereinafter, simply referred to as a “power battery”) a plug-in hybrid vehicle (PHEV) or an electric vehicle includes for example, a wireless (noncontact) power transmission technology not requiring a physical connection such as a plug connection is used in order to facilitate charging work.

For example, a power supply system disclosed, in PTL 1 includes a power supply part disposed on the ground in a facility and a power receiving part attached to a lower surface of a vehicle. In such power supply system the power supply part and the power receiving part each have a coil unit including a coil. The coil units of the power supply part and the power receiving part are arranged to face each other, implementing noncontact power transmission.

The coil unit includes such a board body having a circuit board and a plurality of capacitors mounted on the circuit body other than the coil for example. Furthermore the coil unit includes a coil and a case housing the board body. The board body is housed in the case adjacent to the coil, an extension line drawn from the coil and a terminal disposed on the circuit board are fixed with a screw and connected, and thereby forming together with the coil a resonance circuit,

### Patent Document

PTL 1: Japanese Patent Publication 2013-90470

### SUMMARY OF THE INVENTION

Disadvantageously, because an iron or stainless-made screw is used as a screw fixing the extension line of the coil and a circuit board of the board body for securement of fixing strength or the like, arrangement of the board body adjacent to the coil induces magnetic flux of the coil passing thought the screw so as to generate eddy current, which is consumed by an electrical resistance the screw has, posing a problem of producing heat. Furthermore, the same is applied to as a screw fixing the case and the circuit board. And the heat of the screw in the case poses a problem that accelerates temperature rise of the coil unit.

The present invention is intended to solve the concerned problems. Namely, the present invention is to aim at providing a coil unit capable of suppressing heat generated in a coil unit, and a power supply system including the coil unit.

The invention according to a first aspect, in order to achieve the abovementioned object, is a coil unit used for noncontactly transmitting/receiving power, characterized by including a coil; aboard body including a circuit board; and at least one fixing members of fixing the circuit board of the board body and a wiring, and of fixing the wirings to each other, and by that the fixing member includes copper or aluminum.

The invention according to a second aspect is characterized in that in the invention according to the first aspect, the fixing member is arranged to fix an edge of the circuit board and the wiring, the edge being separated from the coil.

The invention according to a third aspect is characterized in that in the invention according to the first or second aspect, the fixing member is configured such that by fixing the circuit board and the wiring, wiring patterns of both sides of the circuit board are electrically connects.

The invention according to a fourth aspect is, in order to achieve the abovementioned object, a power supply system characterized in that a power supply part disposed on the ground; a power receiving part disposed in a vehicle are included, that the power receiving part noncontactly receiving power transmitted from the power supply part, and that at least one of the power supply part and the power receiving part includes the coil unit according to any one of the first to third aspects.

According to the invention of the first or the fourth aspect includes at least one of fixing members of fixing the circuit board and a wiring of the board body and of fixing the wirings to each other, and the fixing member includes copper or aluminum. Thus, for example, compared with a fixing member made of iron or stainless, an electrical resistance of the fixing member can be reduced. Therefore, in the case that the magnetic flux passes through the fixing member and the eddy current is induced, it is possible to suppress the heat generated of the fixing member by the eddy current. Thus it is possible to suppress the heat generated in the coil unit.

The invention according to the second aspect, the fixing member is disposed to fix the edge of the circuit board apart from the coil and the wiring. It follows from this that separation from the coil decreases the magnetic flux, and reduces the eddy current generated in the fixing member. Therefore, the heat of the fixing member generated by this eddy current can be suppressed.

According to the invention of the third aspect, since the fixing member fixes the circuit board and the wiring, the wiring patterns of both sides of the concerned circuit board are configured to be electrically connected. This makes that also in the through hole connecting the wiring patterns of the both sides of the circuit board, though the eddy current by the magnetic flux of the coil may be induced which generates heat, the number of the through holes is reduced, further suppressing the generated heat.

### BRIEF DESCRIPTION OF THE DRAWINGS

FIG. 1 is a view illustrating a schematic configuration of a power supply system of one embodiment of the present invention;

FIG. 2 is a view explaining an arrangement of a power supply unit and a power receiving unit the power supply system in FIG. 1 includes;

FIG. 3 is an exploded perspective view of the power receiving unit of FIG. 2; and

FIG. 4 is a cross-sectional view of a power receiving side capacitor body the power receiving unit in FIG. 2 includes.

### DETAILED DESCRIPTION OF THE PREFERRED EMBODIMENTS

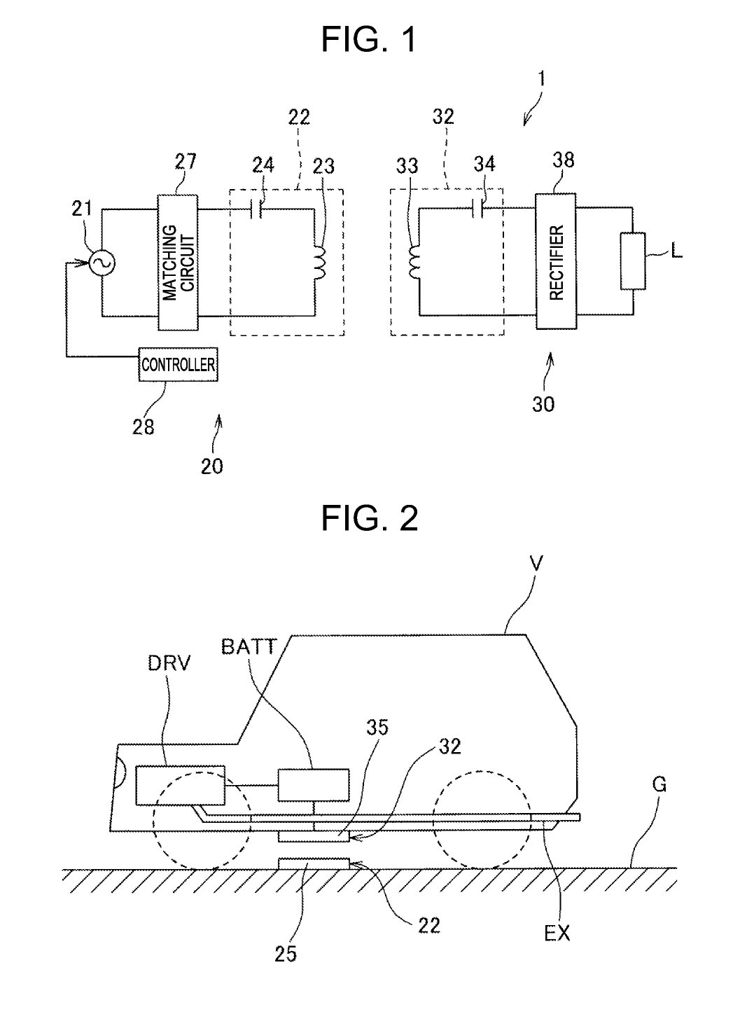

Hereafter, with reference to FIGS. 1-4 a power supply system of one example of the present invention will be described.

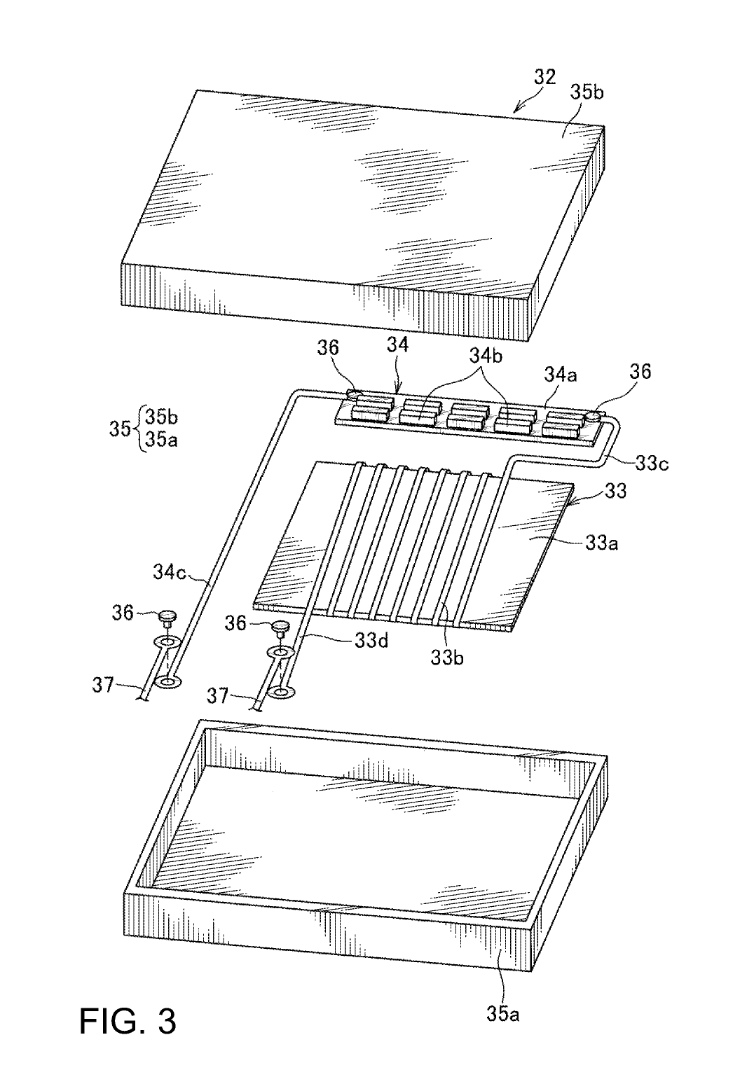

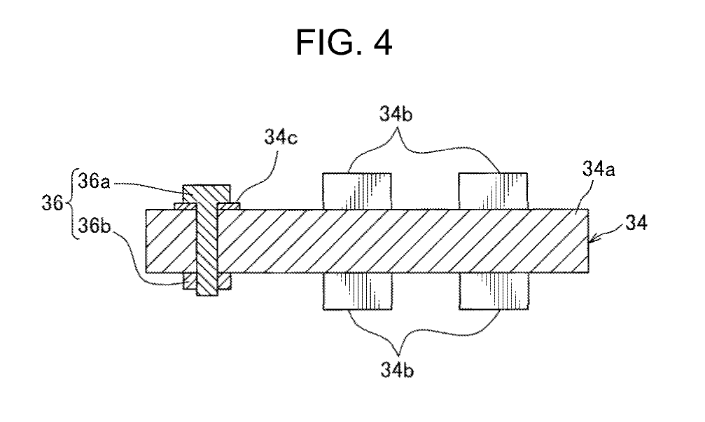

FIG. 1 is a schematic view illustrating a power supply system of one embodiment of the present invention. FIG. 2 is a view explaining an arrangement of a power supply unit and a power receiving unit the power supply system of FIG. 1 includes. FIG. 3 is an exploded perspective view of the power receiving unit of FIG. 2. FIG. 4 is a cross-sectional view of a power receiving capacitor body the power receiving unit of FIG. 2 includes.

The power supply system of the present invention noncontactly supplies power to a vehicle from the ground by using magnetic field resonance system. Note that systems other than magnetic field resonance system may be used in which electromagnetic coupling between a power supplier and a power receiver could transmit power.

As illustrated in FIG. 1, the power supply system 1 includes a power supply device 20 as a power supply part arranged on the ground G (shown in FIG. 2), and a power receiving device 30 as a power receiving part arranged in a vehicle V (shown in FIG. 2). This vehicle V is provided with a drive unit DRV including an engine and a motor, a power battery BATT supplying power to the motor, and an exhaust pipe EX exhausting exhaust gas of the engine. In FIG. 2 left side denotes a front side of the vehicle V.

The vehicle 20 includes a high-frequency power supply 21, a power supply unit 22, a matching circuit 27, and a controller 28.

The high-frequency power supply 21 generates and supplies a high-frequency power from a commercial power source to a power supply unit 22 mentioned later. The high-frequency power generated by the high-frequency power source 21 is set to a frequency equal to a resonance frequency of the power supply unit 22 and a resonance frequency of a power receiving unit 32 mentioned later.

The power supply unit 22 includes a power supply side coil 23 and a power supply side capacitor body 24. These power supply side coil 23 and power supply side capacitor body 24 are housed in the power supply side case 25 made of material capable of flowing magnetism such as fiber reinforced plastic (FRP) for example. The power supply unit 22 is, as shown in FIG. 2, arranged on the ground G The power supply unit 22 may be embedded in the ground G.

The power supply side coil 23 is configured such that litz wire (a conductor in which a plurality of enameled fine wires is braided) is wound around a not-shown ferrite-made core. The power supply side capacitor body 24 includes a plurality of not-shown capacitors in series or in parallel, or in series and in parallel connected to each other to a not-shown circuit board and mounted thereto. The power supply side coil 23 and the power supply side capacitor body 24 are connected in series to each other, configuring a resonance circuit resonating with a predetermined resonance frequency. In the present embodiment the power supply side coil 23 and the power supply side capacitor body 24 are connected in series, but may be connected in parallel.

The matching circuit 27 is a circuit for matching impedances between the high-frequency power source 21 and the resonance circuit composed of the power supply side coil 23 and the power supply side capacitor body 24.

The controller 28 is composed of such a known microcomputer including a ROM, RAM, and CPU, and controls the whole of the power supply device 20. The controller 28 turns on or off the high-frequency power source 21 in accordance with a power transmission command for example.

The power receiving device 30 includes a power receiving unit 32 as a coil unit and a rectifier 38.

The power receiving unit 32 is, as shown in FIG. 3, provided with a power receiving side coil 33 as a coil, a power receiving side capacitor body 34 as a board body, a box-like power receiving side case 35 as a case for housing them, and a plurality of fixing members 36 as fixing member.

The power receiving side coil 33 includes a ferrite-made rectangular plate-like core 33a, a coil wire 33b composed of litz wire wound around the core 33a in a coil-like fashion.

The power receiving side capacitor body 34 includes a rectangular plate-like circuit board 34a in which a wiring pattern is formed on a surface of a glass epoxy board, and a plurality of ceramic capacitors 34b mounted on the surface of the circuit board 34a and in series or in parallel, or in series and in parallel connected to each other.

The power receiving side coil 33 and the power receiving side capacitor body 34 are connected to each other and forms a resonance circuit resonating with the same frequency as the power supply unit 22. In the present embodiment, the power receiving side coil 33 and the power receiving side capacitor body 34 are connected in series, but may be connected in parallel.

The power receiving side case 35 is dividably formed into a main body 35a and a cover 35b. The main body 35a is formed of material such as FRP capable of passing magnetism from the power supply device 20 for example, The cover 35b is formed of material such as aluminum or aluminum alloy capable of not passing magnetism (that becomes magnetic shield) for example. Furthermore, the cover 35b is also resin-made such as FRP in the same fashion as the main body 35a, and such a magnetic shield plate composed of copper and aluminum may be disposed above the cover 35b. The power receiving side case 35 forms a space K housing therewithin the power supply side coil 33 and the power receiving side capacitor body 34 by combining, and fixing with a not-shown fixing means like screw the main body 35a and the cover 35h. In the space K of the present invention, the power receiving side coil 33 and the power receiving side capacitor body 34 are arranged horizontally. Furthermore, the power receiving side case 35 is attached to an underside of the vehicle V such that the cover 35b faces an underside of the vehicle, the main body 35a the ground G side.

A plurality of screw bodies 36 is formed of copper (including copper alloy) or aluminum (including aluminum ally) as material, namely, is configured to include copper or aluminum, and thus its electrical resistance more reduces than iron or stainless. Herein by “being configured to include copper or aluminum” is meant that copper or aluminum is included as main component. The plurality of screw bodies 36, as shown in FIG. 4, includes a bolt 36a and a nut 36b screwed together.

A part of screw bodies 36 of the plurality of screw bodies 36 fastens an end of an extension line 33c of one of the power receiving coil 33, one end of the extension line 34c of the power receiving side capacitor body 34, and the circuit board 34a at an end of the circuit board 34a far from the power receiving side coil 33 (left side in FIG. 4). This makes the extension line 33c, the extension line 34c, and the wiring pattern of the circuit board 34a, electrically connected.

Moreover, the part of screw bodies 36 are made that the bolt 36a is electrically connected to the wiring pattern of one side of the circuit board 34a (upper side of FIG. 4) via the extension line 34c (e.g., terminal fining), the nut 36b is electrically connected to the wiring pattern of the other side of the circuit board 34a (lower side of FIG. 4). This makes wiring patterns of both sides of the circuit board 34a electrically connected via the screw body 36.

Moreover, the other part of screw bodies 36 of the plurality of screw bodies 36 fix an end of the other extension line 33d of the power receiving side coil 33, the other end of the extension line 34c of the power receiving side capacitor 34, and a pair of lead wires 37, 37 drawn from inside of the power receiving side case 35 and wired. This makes the extension line 33d, the extension line 34c, and the pair of lead wires 37, 37 electrically connected. The extension line 33c, 33d, the extension line 34c, and the pair of lead wires 37, 37 are one example of wiring.

In the present embodiment the power receiving unit 32 includes two screw bodies fixing the circuit board 34a, the extension line 33c, and the extension line 34c (namely, the part of screw bodies 36), and two screw bodies 36 fixing the extension line 33d, the extension line 34c, and the pair of lead wires 37, 37 (namely, the other part of screw bodies 36).

The rectifier 38 transforms the high-frequency power the power receiving unit 32 receives into a direct current power. This rectifier 38 is connected to a load L such as a charge unit used for charging the power battery BATT that is mounted on the vehicle V for example.

The abovementioned power supply system 1, when a charging operation is inputted for the power battery BATT of the vehicle V parked and a command is generated of transmission of power to the vehicle in the power supply facility, the controller 28 turns on the high-frequency power source 21 so as to generate high-frequency power. Then when the high-frequency power is supplied to the power supply unit 22, the power supply unit 22 and the power receiving unit 32 magnetically resonate, the high-frequency power is transmitted from the power supply unit 22, and the high-frequency power is received by the power receiving unit 32. The high-frequency power received by the power receiving unit 32 is transformed into the direct current power by the rectifier 38, so as to be supplied to the charge unit of the vehicle V, and the power battery BATT is charged by the charge unit.

Next, an effect in the abovementioned power supply system 1 will be explained.

When charging the power battery BAIT of the vehicle V, high-frequency power is transmitted from the power supply unit 22, and power is received by the power receiving unit 32. At this time magnetic field is generated in vicinity of the power receiving side soil 33 of the power receiving unit 32, magnetic flux passes through the part of screw bodies 35 fixing the extension line 33c, the extension line 34c, and the circuit board 34a, inducing eddy current, but because the electrical resistance of the part of screw bodies 36 reduces, the heat generated by the eddy current is made smaller. Moreover, the other part of screw bodies 36 fixing the extension line 33d, the extension line 34c, and the pair of lead wires 37, 37 are applied to the same manner.

Thus, according to the present embodiments, the part of screw bodies 36 fixing the circuit board 34a of the power receiving side capacitor 34, and the extension line 34c, and the other part of screw bodies 36 fixing the extension line 33d, the extension line 34c, and the pair of lead wires 37, 37 are included. The plurality of screw bodies 36 is configured to include copper and aluminum. This makes the electrical resistance of the screw bodies 36 reduced, compared with iron or stainless-made screw bodies. Therefore, even if the magnetic flux of the power receiving side coil 33 passed through the plurality of screw bodies 36 and eddy current generated, heat generated in the plurality of screw bodies 36 by this eddy current could be reduced. Accordingly the heat generated in the power receiving unit 32 can be suppressed. This makes a decrease of transmission efficiency of power by increase of resistance of the power receiving side coil 33, or an excess of the capacitor temperature over usable temperature upper limit suppressed.

Moreover, the part of screw bodies 36 are provided so as to fix the edge of the circuit board 34a far from the power receiving side coil 33, the extension line 33c, and the extension line 34c. This makes magnetic flux reduced by separation from the power receiving side coil 33, and the eddy current generated in the part of screw bodies 36 reduced. Therefore, the heat generated in the part of screw bodies 36 by this eddy current can be suppressed.

Moreover, the part of screw bodies 36 are configured to electrically connect wiring patterns on both sides of the concerned circuit board 34a by fixing the circuit board 34a, the extension line 33a, and the extension line 34c. This makes the generated heat further reduced by reduction of through holes regardless that the eddy current is also generated by magnetic flux of the power receiving side coil 33 at the through holes electrically connecting wiring patterns on both sides of the circuit board 34a.

As mentioned above, while preferred embodiments were taken up and explained, the coil unit and the power supply system of the present invention are not limited thereto.

For example, the configuration of the power supply unit 22 of aforementioned configuration is made similar to the aforementioned power receiving unit 32, that is, the screw bodies fixing the circuit board of the power supply side capacitor 24 and the wiring, and screw bodies fixing the wirings to each other may be configured to include copper or aluminum so as to reduce electrical resistance. In this case the power supply unit 22 is one example of the coil unit.

Moreover, it is configured that in the abovementioned embodiments the part of screw bodies 36 fixing the circuit board 34a of the power receiving side capacitor 34, the extension line 33c, and the extension line 34c, and the other part of screw bodies 36 fixing the extension line 33d, the extension line 34c, and the pair of lead wires 37, 37 include copper or aluminum, but the invention is not limited thereto, for example, when arranged apart from the power receiving coil 33, and heat by the eddy current is small, one of screw bodies 36 may be configured to be formed with material other than copper or aluminum.

Moreover, it is configured that in the abovementioned embodiments, the screw bodies 36 including the bolt 36a and the nut 36b is provided, but the invention is not limited thereto, for example, such a configuration including a rivet or the like as possibly fixing the circuit board and the wiring or wirings to each other may be arbitrary unless contrary to the object of the present invention.

The aforementioned embodiments only show typical configurations of the present invention, and the present invention should not be limited thereto. Namely, those skilled in the art, following conventional knowledges, can practice varying in many types without departing from the gist of the present invention. Such variations are, as far as provided with the coil unit and the power supply system of the present invention, included in the scope of the present invention.

### DESCRIPTION OF SYMBOLS

1 power supply system
20 power supply device (power supply part)
22 power supply unit
30 power receiving device (power receiving part)
32 power receiving unit (coil unit)
33 power receiving side coil (coil)
33a core
33b coil wire
33d extension line (wiring)
34 power receiving side capacitor (board body)
34a circuit board
34b ceramic capacitor
34c extension line (wiring)
35 power receiving side case
36 screw body (fixing member)
37 lead wire (wiring)
G ground
V vehicle

What is claimed is:

1. A coil unit used for noncontactly transmitting/receiving power, comprising:
a coil;
a board body including a circuit board; and
at least one of fixing members of fixing the circuit board of the board body and a wiring, and of fixing the wirings to each other, wherein
the fixing member includes copper or aluminum.

2. The coil unit according to claim 1, wherein the fixing member is arranged to fix an edge of the circuit board and the wiring, the edge being far from the coil.

3. The coil unit according to claim 1, wherein the fixing member is configured such that wiring patterns of both sides of the circuit board are electrically connected by fixing the circuit board and the wiring.

4. The coil unit according to claim 2, wherein the fixing member is configured such that wiring patterns of both sides of the circuit board are electrically connected by fixing the circuit board and the wiring.

5. A power supply system comprising:
a power supply part disposed on the ground; and
a power receiving part disposed in a vehicle, wherein
the power receiving part noncontactly receiving power transmitted from the power supply part, and wherein
at least one of the power supply part and the power receiving part includes the coil unit according to claim 1.

6. A power supply system comprising:
a power supply part disposed on the ground; and
a power receiving part disposed in a vehicle, wherein
the power receiving part noncontactly receiving power transmitted from the power supply part, and wherein
at least one of the power supply part and the power receiving part includes the coil unit according to claim 2.

7. A power supply system comprising:
a power supply part disposed on the ground; and
a power receiving part disposed in a vehicle, wherein
the power receiving part noncontactly receiving power transmitted from the power supply part, and wherein
at least one of the power supply part and the power receiving part includes the coil unit according to claim 3.

8. A power supply system comprising:
a power supply part disposed on the ground; and
a power receiving part disposed in a vehicle, wherein
the power receiving part noncontactly receiving power transmitted from the power supply part, and wherein
at least one of the power supply part and the power receiving part includes the coil unit according to claim 4.
